(19) United States
(12) Patent Application Publication
(10) Pub. No.: US 2016/0068151 A1
(43) Pub. Date: Mar. 10, 2016

(54) METHOD FOR CONTROLLING COASTING TORQUE OF HYBRID VEHICLE

(71) Applicant: HYUNDAI MOTOR COMPANY, Seoul (KR)

(72) Inventors: Young Chul Kim, Seoul (KR); Sang Joon Kim, Seoul (KR)

(21) Appl. No.: 14/570,658

(22) Filed: Dec. 15, 2014

(30) Foreign Application Priority Data
Sep. 5, 2014 (KR) 10-2014-0118336

(51) Int. Cl. B60W 20/00

(52) U.S. Cl. CPC B60W 20/106; B60W 2710/0666

(57) ABSTRACT

A method for controlling coasting torque of a hybrid vehicle includes: determining a final coasting torque by adding, for each manual gear shifting step, an engine friction torque to: i) a first correction torque for conserving a state of charge (SOC) of a high-voltage battery of the hybrid vehicle, ii) a second correction torque according to a vehicular electronic component load, and iii) a coasting correction torque based on a road gradient, when the hybrid vehicle enters a coasting mode; and applying a coasting torque amount for coasting driving to the determined final coasting torque.

### CROSS-REFERENCE TO RELATED APPLICATION

This application claims under 35 U.S.C. §119(a) the benefit of and priority to Korean Patent Application No. 10-2014-0118336 filed on Sep. 5, 2014, the entire contents of which are incorporated herein by reference.

### BACKGROUND

(a) Technical Field

The present disclosure relates to a method for controlling coasting torque of a hybrid vehicle. More particularly, it relates to a method that can control coasting torque at the time of entering a coasting mode (e.g., not pressing brake or acceleration pedals) to achieve an improvement in fuel efficiency and drivability.

(b) Background Art

As illustrated in FIG. 1, a power transmission system for a hybrid vehicle may be configured to include, for example, an engine 10 and a motor 12 arranged in series with each other, an engine clutch 13 arranged between the engine 10 and the motor 12 to transmit or cut off engine power, an automatic transmission 14 shifting motor power and engine power to a driving wheel and outputting the same, a hybrid starter generator (HSG) 16 that is connected to a crank pulley of the engine to transmit power in order to start the engine and generate power, an inverter 18 that controls the motor and the power generation, and a high-voltage battery 20 connected to the inverter 18 to be chargeable and dischargeable so as to supply power to the motor 12. The power transmission system for a hybrid vehicle can be referred to as a transmission mounted electric device (TMED) scheme and implement driving modes, including an electric vehicle (EV) mode, which is a pure electric vehicle mode using only the motor power, a hybrid electric vehicle (HEV) mode, which uses the motor as sub power while using the engine as main power, a regenerative braking (RB) mode, which collects braking and inertial energy of the vehicle through the power generation of the motor in order to charge the collected energy in the battery while braking in the vehicle, driving the vehicle by inertia, and the like.

In the HEV mode, a hybrid vehicle is driven by the sum of output torques of the engine and the motor simultaneously with a locking of the engine clutch. In the EV mode, the vehicle is driven only by an output torque of the motor simultaneously with an opening of the engine clutch. Among the driving modes, the EV and HEV driving modes can be achieved through a normal mode representing “accelerator-on” and “brake-off” states, and the regenerative braking mode can be achieved in “accelerator-off” and “brake-on” states. The driving modes may also include a coasting mode representing the “accelerator-off” and “brake-off” states, in addition to the normal mode and the regenerative braking mode. Also, in the coasting mode, a braking operation may be performed together with a coasting operation, depending on manual gear shifting of the automatic transmission.

When the engine clutch synchronizes speeds of the engine and the motor, and a driver performs a manual shifting operation while the engine and the motor are joined to each other, a conventional coasting mode is achieved by a scheme in which a coasting torque amount (e.g., a braking torque amount) during the coasting operation is controlled in the motor. For example, the coasting mode can be achieved by a scheme in which braking torque for deceleration is set differently for each shifted gear step in an accelerator pedal release state and the braking torque amount can be controlled using the motor, as illustrated in FIG. 2.

The coasting driving is performed when both the accelerator pedal and the brake pedal are released in the coasting mode. In this case, when the driver performs manual gear shifting, an effect in which engine braking of a gasoline engine is performed by controlling the coasting torque amount in the motor. However, with respect to the coasting torque control in the conventional coasting mode, since the coasting torque amount is determined in the motor for each manual gear shifting step without considering a state of charge (SOC) of the high-voltage battery, a usage state of an electronic component load, a road gradient state, and the like, fuel efficiency may decrease depending on discharge of the high-voltage battery and current consumption of the electronic component load. Further, as the road gradient state is not considered, vehicle drivability may deteriorate.

The above information disclosed in this Background section is only for enhancement of understanding of the background of the disclosure and therefore it may contain information that does not form the related art that is already known in this country to a person of ordinary skill in the art.

### SUMMARY OF THE DISCLOSURE

The present disclosure has been made in an effort to solve the above-described problems associated with related art. In particular, the present disclosure, provides a method for controlling coasting torque of a hybrid vehicle that applies a coasting torque amount (e.g., braking torque amount) in a coasting mode to a final coasting torque acquired by adding a torque for conserving a state of charge (SOC) of a high-voltage battery (e.g., main battery), a torque based on a vehicular electronic component load, and a coasting torque based on a road gradient to an engine friction torque for each gear of an engine. Accordingly, drivability can be improved by satisfying a required torque of a driver, and fuel efficiency can be similarly improved by conserving the SOC of the high-voltage battery in a charge-oriented manner.

According to embodiments of the present disclosure, a method for controlling coasting torque of a hybrid vehicle includes: determining a final coasting torque by adding, for each manual gear shifting step, an engine friction torque to: i) a first correction torque for conserving a state of charge (SOC) of a high-voltage battery of the hybrid vehicle, ii) a second correction torque according to a vehicular electronic component load, and iii) a coasting correction torque based on a road gradient, when the hybrid vehicle enters a coasting mode; and applying a coasting torque amount for coasting driving to the determined final coasting torque. The method for controlling coasting torque of a hybrid vehicle may further include: extracting the first correction torque, the second correction torque, and the coasting correction torque from map data constructed through an experiment.

The first correction torque increases when the SOC of the high-voltage battery is a low SOC and decreases when the SOC of the high-voltage battery is a high SOC.

The second correction torque increases as the electronic component load increases.

The coasting correction torque increases during uphill driving and decreases during flatland driving.

Furthermore, according to embodiments of the present disclosure, an apparatus for controlling coasting torque of a hybrid vehicle includes: a memory storing program instructions; and one or more processors configured to execute the stored program instructions, which when executed perform a process including: determining a final coasting torque by adding, for each manual gear shifting step, an engine friction torque to: i) a first correction torque for conserving a state of charge (SOC) of a high-voltage battery of the hybrid vehicle, ii) a second correction torque according to a vehicular electronic component load, and iii) a coasting correction torque based on a road gradient, when the hybrid vehicle enters a coasting mode, and applying a coasting torque amount for coasting driving to the determined final coasting torque.

Furthermore, according to embodiments of the present disclosure, a non-transitory computer readable medium containing program instructions for controlling coasting torque of a hybrid vehicle includes: program instructions that determine a final coasting torque by adding, for each manual gear shifting step, an engine friction torque to: i) a first correction torque for conserving a state of charge (SOC) of a high-voltage battery of the hybrid vehicle, ii) a second correction torque according to a vehicular electronic component load, and iii) a coasting correction torque based on a road gradient, when the hybrid vehicle enters a coasting mode; and program instructions that apply a coasting torque amount for coasting driving to the determined final coasting torque.

Accordingly, when a hybrid vehicle is driven in an HEV mode, at the time of entering a coasting mode representing “accelerator-off” and “brake-off” states (i.e., neither the accelerator nor brake is active), a coasting torque (i.e., braking torque amount) for coasting driving is applied to a final coasting torque acquired by adding a correction torque for conserving an SOC of a high-voltage battery (i.e., “first correction torque”), a correction torque considering a vehicular electronic component load (i.e., “second correction torque”), and a coasting torque depending on a road gradient to an engine friction torque for each manual gear step, fuel efficiency is improved by conserving the SOC of the high-voltage battery in a charge-oriented manner. Moreover, a required torque of a driver is satisfied due to correction of the coasting torque, based on the road gradient, to improve drivability.

Other aspects and preferred embodiments of the disclosure are discussed infra.

### BRIEF DESCRIPTION OF THE DRAWINGS

The above and other features of the present disclosure will now be described in detail with reference to embodiments thereof illustrated in the accompanying drawings which are given hereinbelow by way of illustration only, and thus are not limitative of the present disclosure, wherein:

FIG. 1 is a schematic view illustrating a configuration of a power transmission system for a hybrid vehicle;

FIG. 2 is a graph illustrating a conventional control example of a coasting torque at the time of entering a coasting mode;

FIG. 3 is a conceptual diagram illustrating a method for controlling a coasting torque of a hybrid vehicle according to the present disclosure;

FIG. 4 is a graph illustrating a final coasting torque for each gear step at the time of controlling the coasting torque of the hybrid vehicle according to the present disclosure; and

FIG. 5 is a flowchart illustrating the method for controlling a coasting torque of a hybrid vehicle according to the present disclosure.

Reference numerals set forth in the Drawings includes reference to the following elements as further discussed below:

10: engine

12: motor

13: engine clutch

14: automatic transmission

16: HSG

18: inverter

20: battery

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment. In the figures, reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. While the disclosure will be described in conjunction with embodiments, it will be understood that present description is not intended to limit the disclosure to those embodiments. On the contrary, the disclosure is intended to cover not only the embodiments, but also various alternatives, modifications, equivalents and other embodiments, which may be included within the spirit and scope of the disclosure as defined by the appended claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and one or more processors. The memory is configured to store program instructions, and the processor is configured to execute the program instructions to perform one or more processes which are described further below. Moreover, it is understood that the below methods may be executed by an apparatus comprising the control unit, whereby the apparatus is known in the art to be suitable for controlling coasting torque of a hybrid vehicle.

Furthermore, the controller of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

As described above, a coasting mode of a hybrid vehicle is performed in an “accelerator-off” and “brake-off” state (i.e., neither the accelerator nor brake is active (e.g., pressed)) during EV and HEV driving modes, and braking, such as engine braking, is achieved during the coasting mode. The present disclosure is characterized in that a coasting torque (i.e., braking torque amount) during coasting driving (in the coasting mode) is controlled with a final coasting torque acquired by adding a correction torque for conserving an SOC meaning a charge amount of a high-voltage battery (i.e., “first correction torque”), a correction torque considering a vehicular electronic component load (i.e., “second correction torque”), and a coasting correction torque depending on a road gradient to an engine friction torque (i.e., engine braking torque).

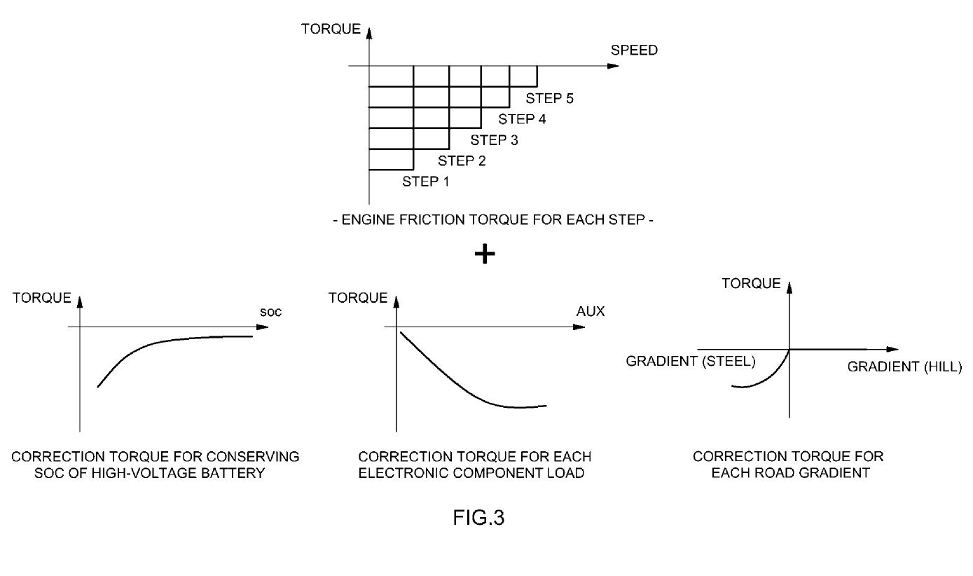

FIG. 3 is a conceptual diagram illustrating a method for controlling a coasting torque of a hybrid vehicle according to the present disclosure. FIG. 5 is a flowchart illustrating the method for controlling a coasting torque of a hybrid vehicle according to the present disclosure.

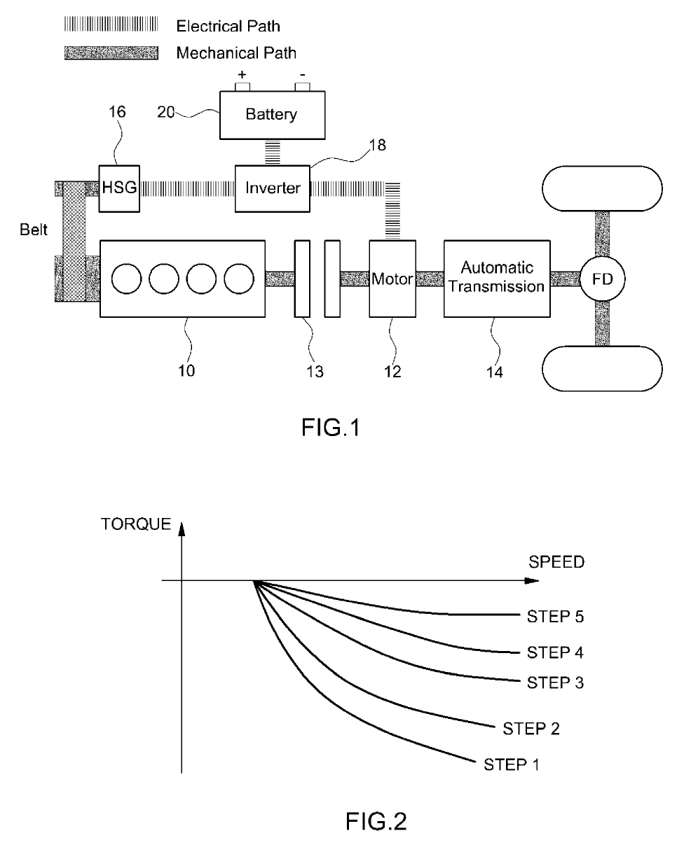

When the hybrid vehicle enters the coasting mode, a driver personally converts an automatic transmission to a manual mode (e.g., sports mode or the like) to perform shifting like a manual gear and therefore, an engine friction torque is changed for each manual gear shifting step as illustrated in FIG. 3 and the vehicle is braked by the engine friction torque (i.e., engine braking torque). Of course, as illustrated in a power transmission system diagram of FIG. 1, an engine clutch 13 arranged between an engine 10 and a motor 12 is joined, and as a result, the engine friction torque is changed for each manual gear shifting step when the driver performs shifting, while engine and motor power are transmitted to a driving wheel through an automatic transmission 14. In this case, a correction torque based on the SOC of the high-voltage battery, a usage of an electronic component load, a road gradient situation, and the like, are added to the engine friction torque for each manual gear shifting step to be applied to the coasting torque for the coasting driving.

In more detail, a final coasting torque acquired by adding a correction torque for conserving an SOC meaning a charge amount of the high-voltage battery (i.e., “first correction torque”), a correction torque considering a vehicular electronic component load (i.e., “second correction torque”), and a coasting correction torque depending on a road gradient to an engine friction torque (i.e., engine braking torque) for each manual gear shifting step at the time of entering the coasting mode is used as the braking torque in the coasting driving. Preferably, the correction torque for conserving the SOC of the high-voltage battery, the correction torque considering the vehicular electronic component load, and the correction torque depending on the road gradient may be extracted from map data constructed through an experiment.

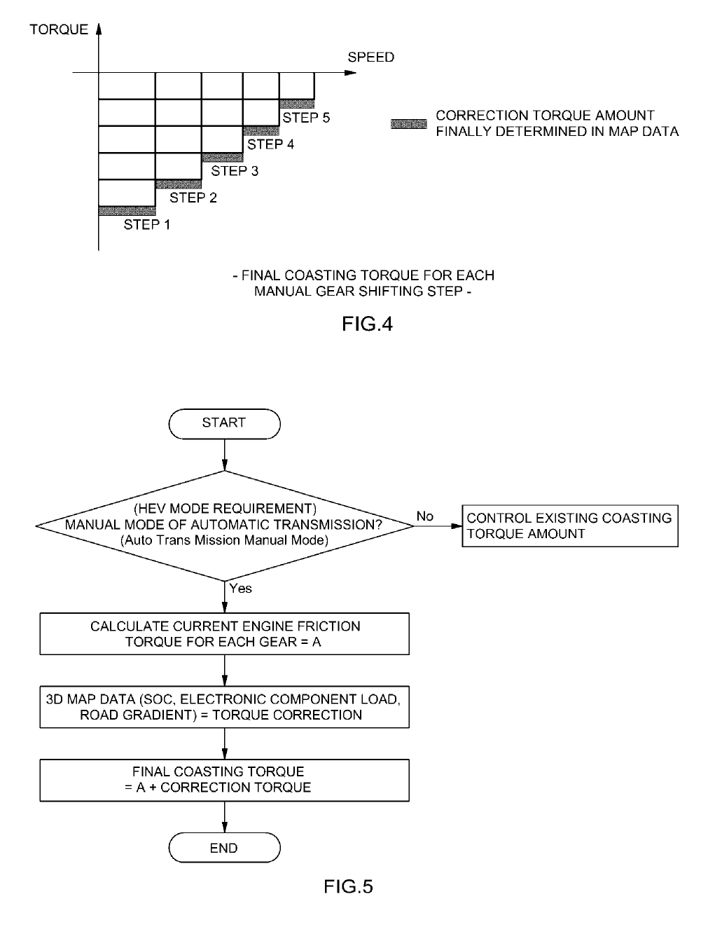

When the correction torque for conserving the SOC of the high-voltage battery, the correction torque considering the vehicular electronic component load, and the correction torque depending on the road gradient which are extracted from the map data are added to the engine friction torque (i.e., engine braking torque), the final coasting torque (i.e., final braking torque amount) acquired by adding the respective correction torques to the engine friction torque for each gear step is determined as illustrated in FIG. 4.

As illustrated in FIG. 3, the correction torque for conserving the SOC of the high-voltage battery as a motor torque increases when the SOC of the high-voltage battery is a low SOC and decreases when the SOC of the high-voltage battery is a high SOC. That is, when the SOC of the high-voltage battery is the low SOC, the correction torque (i.e., motor torque) for conserving the SOC of the high-voltage battery is applied to a level to increase for charge orientation and when the SOC of the high-voltage battery is the high SOC, the correction torque (i.e., motor torque) is applied to a level to decrease for conserving a battery charge amount.

The correction torque considering the vehicular electronic component load as the motor torque is applied to a level to increase for the charge orientation of the motor in the high-voltage battery as the electronic component load (e.g., an AUX including AC power, and the like) increases. That is, since the SOC amount of the high-voltage battery decreases as the electronic component load, the motor torque which is the correction torque based on the vehicular electronic component load increases so as to perform a charging operation in the high-voltage battery in order to conserve the SOC of the high-voltage battery.

The coasting correction torque based on the road gradient as the motor torque increases during uphill driving and decreases during flatland driving. Therefore, greater amounts of uphill driving may be performed for a required torque of the driver by increasing the coasting correction torque during uphill driving along with operating in the coasting mode.

As described above, when the hybrid vehicle is driven in an HEV mode, at the time of operating in a coasting mode, a coasting torque (i.e., braking torque amount) is applied to a final coasting torque acquired by adding a correction torque for controlling the SOC of a high-voltage battery and a correction torque based on the vehicular electronic component load to the engine friction torque for each manual gear step in order to improve fuel efficiency by conserving the SOC of the high-voltage battery in a charge-oriented manner. Then, the final coasting torque may be further added to the coasting torque based on the road gradient, and as a result, the required torque of the driver is satisfied according to the road gradient situation, thereby improving drivability.

The disclosure has been described in detail with reference to embodiments thereof. However, it will be appreciated by those skilled in the art that changes may be made in these embodiments without departing from the principles and spirit of the disclosure, the scope of which is defined in the appended claims and their equivalents.

What is claimed is:

1. A method for controlling coasting torque of a hybrid vehicle, comprising:
determining a final coasting torque by adding, for each manual gear shifting step, an engine friction torque to: i) a first correction torque for conserving a state of charge (SOC) of a high-voltage battery of the hybrid vehicle, ii) a second correction torque according to a vehicular electronic component load, and iii) a coasting correction torque based on a road gradient, when the hybrid vehicle enters a coasting mode; and
applying a coasting torque amount for coasting driving to the determined final coasting torque.

2. The method of claim 1, further comprising:
extracting the first correction torque, the second correction torque, and the coasting correction torque from map data constructed through an experiment.

3. The method of claim 1, wherein the first correction torque increases when the SOC of the high-voltage battery is a low SOC and decreases when the SOC of the high-voltage battery is a high SOC.

4. The method of claim 1, wherein the second correction torque increases as the electronic component load increases.

5. The method of claim 1, wherein the coasting correction torque increases during uphill driving and decreases during flatland driving.

6. An apparatus for controlling coasting torque of a hybrid vehicle, comprising:
a memory storing program instructions; and
one or more processors configured to execute the stored program instructions, which when executed perform a process including:
determining a final coasting torque by adding, for each manual gear shifting step, an engine friction torque to: i) a first correction torque for conserving a state of charge (SOC) of a high-voltage battery of the hybrid vehicle, ii) a second correction torque according to a vehicular electronic component load, and iii) a coasting correction torque based on a road gradient, when the hybrid vehicle enters a coasting mode, and
applying a coasting torque amount for coasting driving to the determined final coasting torque.

7. A non-transitory computer readable medium containing program instructions for controlling coasting torque of a hybrid vehicle, the computer readable medium comprising:
program instructions that determine a final coasting torque by adding, for each manual gear shifting step, an engine friction torque to: i) a first correction torque for conserving a state of charge (SOC) of a high-voltage battery of the hybrid vehicle, ii) a second correction torque according to a vehicular electronic component load, and iii) a coasting correction torque based on a road gradient, when the hybrid vehicle enters a coasting mode; and
program instructions that apply a coasting torque amount for coasting driving to the determined final coasting torque.
